(19) United States
(12) Patent Application Publication
(10) Pub. No.: US 2026/0339750 A1
(43) Pub. Date: Oct. 29, 2026

(54) ADAPTIVE RESOURCE CONFIGURATION FOR DISTRIBUTED COMPUTING PLATFORMS

(71) Applicant: Dell Products L.P., Round Rock, TX (US)

(72) Inventors: Vijay Ragam, Medway, MA (US); Sabu K. Syed, Austin, TX (US); Sarvani Katta, Andhra Pradesh (IN); Varalakshmi Nedunuri, Hyderabad (IN); Souvik Das, Kolkata (IN)

(21) Appl. No.: 19/189,743

(22) Filed: Apr. 25, 2025

(51) Int. Cl. G06F 9/50

(52) U.S. Cl. CPC G06F 9/5083

(57) ABSTRACT

Methods, apparatus, and processor-readable storage media for adaptive resource configuration techniques are provided herein. An example computer-implemented method includes accessing at least one data structure to obtain data comprising one or more feature values for one or more jobs associated with a distributed computing platform and performing a correlation analysis on the obtained data to select at least a set of features relevant to at least one type of computing resource of the distributed computing platform. The computer-implemented method further includes predicting, by at least one machine learning model, a resource configuration to be applied for at least one other job based at least in part on the selected set of the features and dynamically adjusting the at least one type of the computing resource of the distributed computing platform for the at least one other job based at least in part on the predicted resource configuration.

### BACKGROUND

Distributed processing frameworks generally refer to systems designed to execute computational tasks across multiple interconnected computing nodes. Such systems can be configured to process large volumes of data and/or complex processing tasks by distributing workloads among available computing nodes to enable parallel execution, fault tolerance and/or near-linear scalability, for example.

### SUMMARY

Illustrative embodiments of the disclosure provide adaptive resource configuration techniques for distributed computing platforms. An exemplary computer-implemented method includes accessing at least one structure to obtain data comprising one or more feature values for one or more jobs associated with a distributed computing platform and performing a correlation analysis on the obtained data to select at least a set of features relevant to at least one type of computing resource of the distributed computing platform. The computer-implemented method further includes predicting, by at least one machine learning model, a resource configuration to be applied for at least one other job based at least in part on the selected set of the features and dynamically adjusting the at least one type of the computing resource of the distributed computing platform for the at least one other job based at least in part on the predicted resource configuration.

Illustrative embodiments can provide significant advantages relative to conventional techniques. For example, technical problems associated with inefficient memory management and resource allocation in distributed processing systems are mitigated in one or more embodiments by dynamically adjusting computing resources based on configurations predicted by at least one machine learning model. Such embodiments can improve job performance and resource utilization across varying workloads while reducing job failures (e.g., due to out-of-memory (OOM) errors).

These and other illustrative embodiments described herein include, without limitation, methods, apparatus, systems and computer program products comprising processor-readable storage media.

### BRIEF DESCRIPTION OF THE DRAWINGS

FIG. 1 shows an information processing system configured for adaptive resource configuration in an illustrative embodiment.

FIG. 2 shows a distributed computing platform architecture in an illustrative embodiment.

FIG. 3 shows a flow diagram of a training process in an illustrative embodiment.

FIG. 4 shows a visualization of a feature heat map in an illustrative embodiment.

FIG. 5 shows a decision tree in an illustrative embodiment.

FIG. 6 shows a flow diagram of an adaptive resource configuration process in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

Efficient management of computing resources in distributed processing systems remains a significant challenge due to the difficulty of balancing performance and resource utilization. Conventional approaches generally rely on static configurations or manual tuning, which are often inadequate for adapting to the variability of modern workloads. This frequently results in insufficient or excessive resource allocation. Insufficient resource allocation can lead to job failures, excessive garbage collection delays and system instability, while excessive resource allocation often wastes valuable resources with only marginal performance gains.

Conventional approaches also lack the ability to dynamically adjust resource configurations in real time based on job metrics. This inability to adapt to changing conditions (such as sudden spikes in data volume or shifts in data characteristics) leads to performance bottlenecks and/or reduced overall system efficiency. The static nature of these conventional approaches makes them inefficient for diverse workloads and prevents maintaining consistent performance levels in dynamic processing environments.

Embodiments described herein provide techniques for dynamically configuring resource allocations within distributed computing platforms. Some embodiments leverage data-driven models to predict optimal resource configurations based on observed system behavior. At least one embodiment utilizes machine learning (ML) to analyze historical and/or real-time job metrics to predict and adjust configurations of computing resources, including but not limited to memory allocation, CPU allocation, network bandwidth, storage capacity and/or other configurable parameters. These and other embodiments can effectively improve performance, resource utilization and system stability while limiting reliance on manual intervention, relative to conventional approaches.

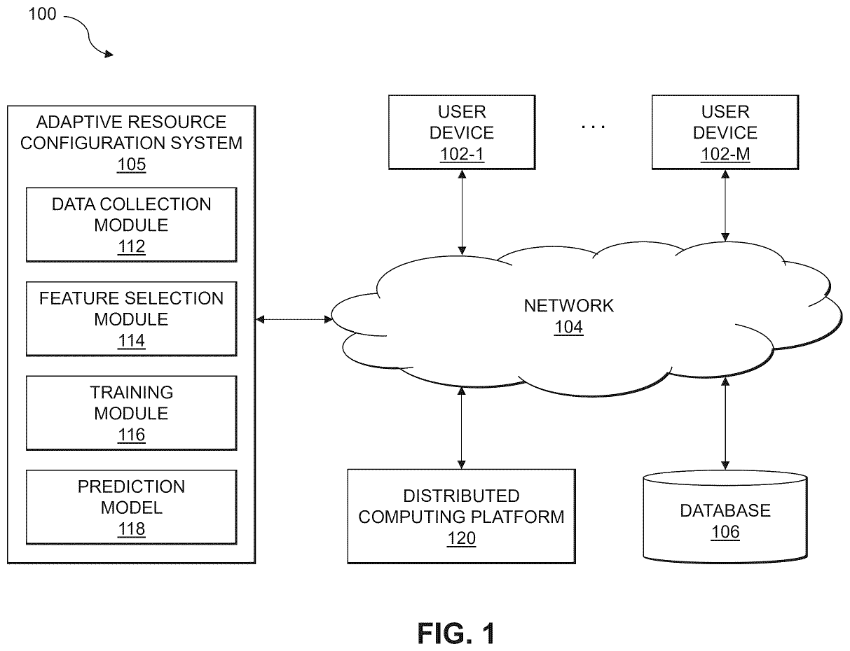

FIG. 1 shows an information processing system 100 configured in accordance with an illustrative embodiment. The information processing system 100 comprises a plurality of user devices 102-1 . . . 102-M (collectively referred to herein as user devices 102), which are coupled to a network 104 Also coupled to network 104 are at least one distributed computing platform 120 and an adaptive resource configuration system 105.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the information processing system 100 may also be referred to herein as collectively comprising an “enterprise network.” Numerous other operating scenarios involving a wide variety of different types and arrangements of processing devices and networks are possible, as will be appreciated by those skilled in the art.

The user devices 102 in some embodiments can be associated with one or more users. It is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the information processing system 100, including a wide area network (WAN), a local area network (LAN), a satellite network, a telephone or cable network, a cellular network, a wireless network such as a Wi-Fi or WiMAX network, or various portions or combinations of these and other types of networks.

The distributed computing platform 120 and/or the adaptive resource configuration system 105 can have at least one associated database 106 configured to store data pertaining to, for example, metrics associated with one or more applications executing on the distributed computing platform 120 as explained in more detail elsewhere herein.

An example database 106, such as depicted in the present embodiment, can be implemented using one or more storage systems associated with the computing platform 109. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the distributed computing platform 120 and/or the adaptive resource configuration system 105 are one or more input-output devices, which illustratively comprise keyboards, displays or other types of input-output devices in any combination. Such input-output devices can be used, for example, to support one or more user interfaces to the distributed computing platform 120 and/or the adaptive resource configuration system 105, as well as to support communication between distributed computing platform 120, the adaptive resource configuration system 105, the user devices 102 and/or other related systems and devices not explicitly shown.

Additionally, the distributed computing platform 120 and/or the adaptive resource configuration system 105 in the FIG. 1 embodiment are assumed to be implemented using at least one processing device. Each such processing device generally comprises at least one processor and an associated memory, and implements one or more functional modules for controlling certain features of the distributed computing platform 120 and/or the adaptive resource configuration system 105.

More particularly, the distributed computing platform 120 and/or the adaptive resource configuration system 105 can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows for communication over the network 104 between the distributed computing platform 120, the adaptive resource configuration system 105 and/or the user devices 102, and illustratively comprises one or more conventional transceivers.

In the FIG. 1 embodiment, the adaptive resource configuration system 105 includes a data collection module 112, a feature selection module 114, a training module 116 and a prediction model 118.

Generally, the data collection module 112 is configured to collect data from various sources within the distributed computing platform 120. In some embodiments, the data collection module 112 may collect both historical and real-time data, such as job execution metrics (e.g., duration, status), resource utilization metrics (e.g., CPU usage, memory consumption and/or network I/O usage), application-specific metrics (e.g., shuffle read/write statistics and/or garbage collection times) and system-level metrics (e.g., cluster load and/or available resources). For example, the data collection module 112 may collect the data from various data sources, such as resource management systems (e.g., Yet Another Resource Negotiator (YARN)), job history servers and/or application logs. The data collection module 112 can convert the collected data into a suitable structured format and store it in the at least one database 106, for example. The structured formats may include comma-separated values (CSV) files and/or relational database formats, as non-limiting examples.

The term “real-time” as used herein is intended to be broadly construed and does not necessarily imply immediate or instantaneous processing. It encompasses a timeframe for data processing and/or response that is short enough to be effective for the intended application. This timeframe may include a short latency period, commonly referred to as “near real-time.” The acceptable latency will vary depending on the specific application and system requirements. In some embodiments, this acceptable latency may correspond to a designated time threshold (e.g., one or more seconds or one or more minutes).

The feature selection module 114 is configured to analyze the data collected by the data collection module 112 and to select a set of features (e.g., the top-k features) that impact job performance and/or resource consumption based on the analysis. The selected features generally include features that have the strongest correlations with resource requirements and/or performance outcomes.

The training module 116 is configured to generate a training dataset based on the selected features and corresponding resource allocation data. The training module 116 can then use the training dataset to train the prediction model 118 to predict resource configurations for incoming jobs or tasks. In some embodiments, the training module 116 can be configured to continuously monitor the performance of the prediction model 118 (e.g., as additional data is collected by the data collection module 112) and trigger alerts and/or corrective actions based on one or more thresholds of the prediction model 118.

The prediction model 118 is configured to obtain data from the distributed computing platform 120 and to generate predictions regarding the appropriate allocation of resources for the distributed computing platform 120. In some embodiments, the distributed computing platform 120 can dynamically adjust resource configurations based on the predictions generated by the prediction model 118, thereby improving performance, resource utilization and/or system stability, for example.

It is to be appreciated that this particular arrangement of elements 112, 114, 116 and 118 illustrated in the adaptive resource configuration system 105 of the FIG. 1 embodiment is presented by way of example only, and alternative arrangements can be used in other embodiments. For example, the functionality associated with the elements 112, 114, 116 and 118 in other embodiments can be combined into a single module or separated across a larger number of modules. As another example, multiple distinct processors can be used to implement different ones of the elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for user devices 102 involving the adaptive resource configuration system 105 and the distributed computing platform 120 of the information processing system 100 is presented by way of illustrative example only, and additional or alternative elements may be used in other embodiments. Thus, another embodiment includes additional or alternative systems, devices and other network entities, as well as different arrangements of modules and other components. For example, in at least one embodiment, one or more of the user devices 102, the adaptive resource configuration system 105 and the distributed computing platform 120 can be on and/or part of the same processing platform.

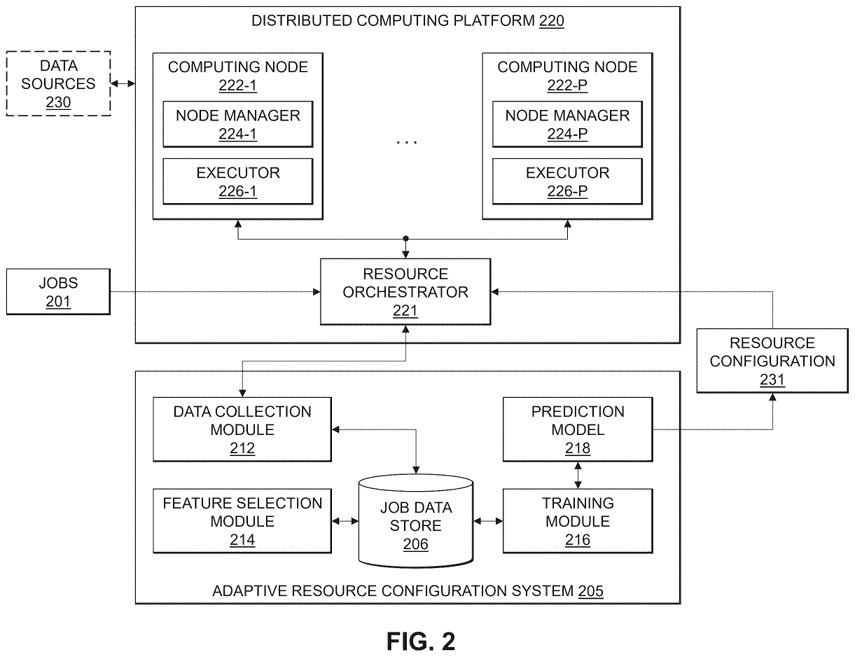

An exemplary process utilizing elements 112, 114, 116 and 118 of an example adaptive resource configuration system 105 in information processing system 100 will be described in more detail with reference to, for example, the diagrams of FIGS. 2, 3 and 5.

FIG. 2 shows a system architecture for adaptive resource configuration in accordance with an illustrative embodiment. The system architecture shown in FIG. 2 includes an adaptive resource configuration system 205 (e.g., corresponding to the adaptive resource configuration system 105) and a distributed computing platform 220 (e.g., corresponding to the distributed computing platform 120).

In the FIG. 2 example, the distributed computing platform 220 includes a resource orchestrator 221 and a plurality of computing nodes 222-1 . . . 222-P, collectively referred to herein as computing nodes 222. The distributed computing platform 220 may optionally (as indicated by the dashed block) be associated with one or more data sources 230. In FIG. 2, the one or more data sources 230 are shown separate from the distributed computing platform 220; however, it is to be appreciated that the one or more data sources 230 may be implemented as a part of the distributed computing platform 220 in other embodiments. The one or more data sources 230 can include, for example, resource management systems, job history servers and/or log servers.

The computing nodes 222 include respective node managers 224-1 . . . 224-P (collectively referred to herein as “node managers 224”) and respective executors 226-1 . . . 226-P (collectively referred to herein as “executors 226”). In this context and elsewhere herein, an executor generally refers to a process configured to execute assigned tasks. Typically, a given executor operates within a resource container and utilizes allocated resources (such as CPU, memory and storage).

In a typical deployment, the node managers 224 manage resources on the corresponding computing nodes 222 and the executors 226 execute tasks associated with one or more jobs 201 assigned by the resource orchestrator 221. In this context and elsewhere herein, the term “job” is intended to be broadly construed so as to encompass a unit of work submitted to the distributed computing platform 220 for processing. A given job may represent, for example, an application, an extract-transform-load (ETL) pipeline, a ML process, a data analysis query, or any other discrete computational workload. The term “task” is intended to be broadly construed so as to encompass a smaller, independent unit of work corresponding to a given job. For example, a job can be decomposed into multiple tasks to enable parallel processing across the computing nodes 222.

In the FIG. 2 example, each of the computing nodes 222 includes a corresponding executor 226; however, it is to be appreciated that a given one of the computing nodes 222 may not implement an executor and/or may execute multiple executors. Thus, in some embodiments, the number of executors 226 may be different than the number of node managers 224 and/or the number of computing nodes 222.

In some embodiments, the computing nodes 222 can comprise one or more worker nodes and at least one coordinator node. In such an embodiment, the worker nodes can perform designated tasks related to at least one of the jobs 201, while the coordinator node can manage task distribution, scheduling, resource allocation and coordination among the worker nodes. In some embodiments, the coordinator node can also manage overall execution control and monitoring of system health and workload distribution. In such embodiments, the coordinator node may implement a driver component that requests resources from the resource orchestrator 221. The resource orchestrator 221 can allocate resources based on the request, and the driver component can launch the executors 226 to execute on the allocated resources.

The adaptive resource configuration system 205 includes a data collection module 212, a feature selection module 214, a training module 216 and a prediction model 218, as well as a job data store 206. Similar to FIG. 1, the data collection module 212 gathers data from the distributed computing platform 220 and/or the data sources 230, including metrics related to job execution, resource utilization and system performance.

In this example, the collected data is stored in the job data store 206 and fed into the feature selection module 214. The feature selection module 214 can be configured to analyze the data in the job data store 206 and to select a set of features in a similar manner as described for the feature selection module 114, for example. The training module 216 utilizes the selected features, along with corresponding resource allocation data, to train the prediction model 218.

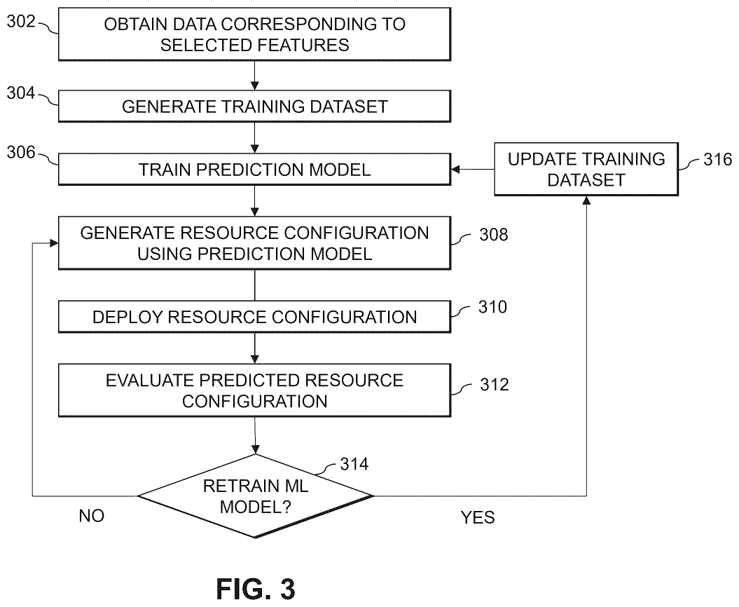

Referring also to FIG. 3, this figure shows an example of a training process, which in some embodiments can be performed at least in part by the training module 216. The process begins at step 302, which includes obtaining data corresponding to the selected features. For example, the data can be retrieved from the job data store 206 and may include historical job execution metrics, resource utilization data and corresponding resource allocation configurations.

Step 304 includes generating a training dataset. In some embodiments, the training dataset may include both training and validation datasets (e.g., 70% training data and 30% validation data) to evaluate the performance of the prediction model 218. The training data can include labeled examples of past job executions where input features (e.g., data size, garbage collection time) are paired with target outputs (e.g., optimal executor resource configurations). Validation data can be used to tune hyperparameters and prevent overfitting. Cross-validation techniques may further validate model robustness.

Step 306 includes training a prediction model (e.g., prediction model 218). In some embodiments, the prediction model 218 is implemented using a regression algorithm applied to the training dataset to learn relationships between input features and target resource configurations. In some embodiments, the regression algorithm can include a random forest regression algorithm, but other algorithms may also be used in alternative embodiments (e.g., Gradient Boosting Machines or K-Nearest Neighbors (KNN)).

In some embodiments, the training process further includes hyperparameter tuning and cross-validation techniques to enhance the performance of the prediction model. Such techniques can help improve the model parameters and prevent overfitting. In some examples, the validation dataset is used to evaluate the performance of the trained prediction model based on metrics such as R-squared and/or Root Mean Squared Error (RMSE). In some embodiments, the training process continues until the prediction model achieves a predetermined threshold of accuracy and/or reliability based on R-squared and/or RMSE threshold values.

Step 308 includes generating a resource configuration using the prediction model. For example, the prediction model can predict a resource configuration based on real-time data. The predicted resource configuration may include values for executor memory allocation, CPU core distribution and other resource parameters, such as off-heap memory limits.

Step 310 includes deploying the resource configuration. For example, the resource configuration can be deployed to the resource orchestrator 221 of the distributed computing platform 220, which then allocates the specified resources to the job.

Step 312 includes evaluating the predicted resource configuration. The evaluation can include comparing the predicted outcomes with actual post-execution metrics (e.g., job completion time, resource utilization, error rates, etc.). In at least some embodiments, the evaluation can also incorporate cost metrics, such as resource utilization efficiency, to ensure predicted configurations balance performance gains with cost constraints.

Step 314 includes a test that determines whether to retrain the machine learning model. For example, step 314 can include determining whether one or more metrics fall below one or more designated thresholds, which may indicate model drift or insufficient adaptability to evolving workloads, based on the results of evaluation in step 312. If the result of step 314 is no, then the process returns to step 308. If the result of step 314 is yes, then step 316 includes updating the training dataset with additional data (e.g., data corresponding to new job executions). The process then returns to step 306, where the model is retrained with the updated dataset.

Referring again to FIG. 2, the prediction model 218, once trained, generates a resource configuration recommendation based on real-time data from the data collection module 212 corresponding to one or more of the jobs 201 submitted to the distributed computing platform 220. The resource configuration recommendation is provided to the resource orchestrator 221 as resource configuration 231.

The resource orchestrator 221 can utilize the resource configuration recommendation to allocate resources for the jobs 201 via the node managers 224 and the executors 226 on the computing nodes 222. Performance data from the distributed computing platform 220 can be fed back to the data collection module 212, continuously updating the job data store 206. This continuous feedback loop can enable the training module 216 to refine the prediction model 218 over time.

As noted above, the feature selection module 114 and/or 214 can utilize correlation analysis techniques to select a set of features that impact job performance and/or resource consumption based on the analysis.

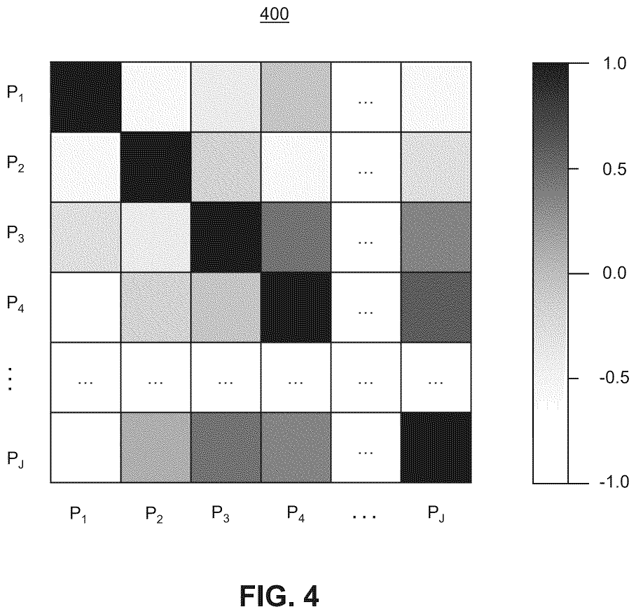

FIG. 4 shows a feature heatmap 400 that visualizes the correlation between various parameters during feature selection in accordance with an illustrative embodiment. The axes of the feature heatmap 400 represent the various parameters (P₁ . . . Pⱼ) collected from the distributed computing platform. As a non-limiting example, the parameters may correspond to a set of feature variables (X) and a target variable (Y), where Y corresponds to at least one resource that is to be predicted (e.g., executor memory).

Each cell within the feature heatmap 400 represents a correlation coefficient between two corresponding parameters, ranging from −1.0 to 1.0. The color intensity indicates the strength and direction of the correlation, where darker shades represent stronger positive correlations, while lighter shades indicate stronger negative correlations. The feature selection process can select at least some of the feature variables having strong positive correlations with Y. For example, the feature selection process can select feature variables satisfying a correlation coefficient threshold and/or a particular number of feature variables. Optionally, the feature heatmap 400 can be output to a user (e.g., corresponding to one of the user devices 102) for verification of the selected features. In other embodiments, the feature selection process can be performed automatically without generating the feature heatmap 400. Accordingly, the correlation analysis enables a robust set of features to be selected for training the prediction model 118 and/or 218.

As previously described, the prediction model 118 and/or 218 can be implemented using a random forest regressor model for predicting resource configurations, which advantageously handles non-linear relationships between input variables. Generally, a random forest regressor model is an ensemble ML model that constructs multiple decision trees during training and aggregates their predictions to generate a final output. For example, a given decision tree can recursively partition data based on feature values, creating a branching structure that leads to predictions at the leaf nodes.

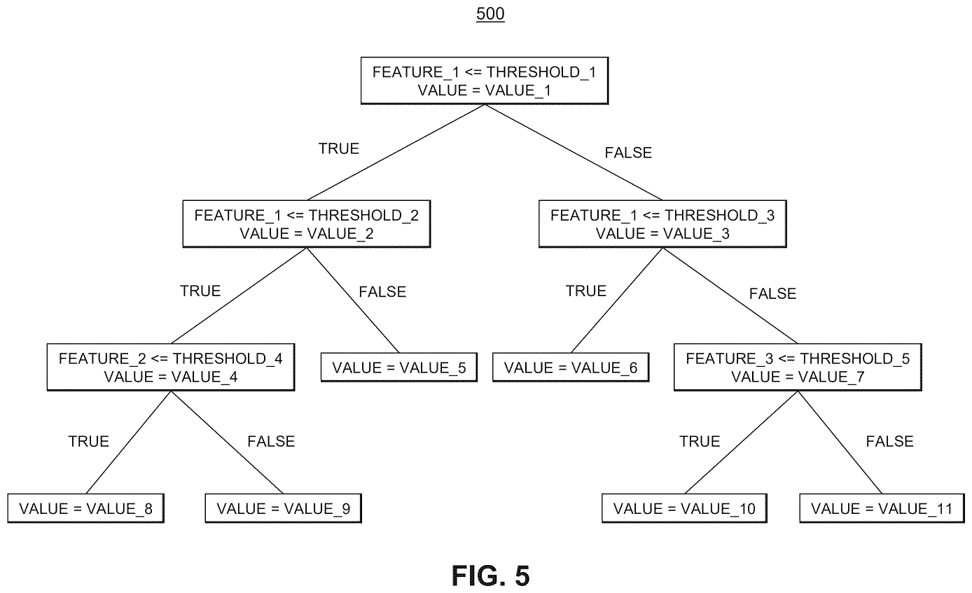

FIG. 5 illustrates an example of a single decision tree 500 corresponding to a random forest regressor model in accordance with an illustrative embodiment. Each internal node represents a test on a specific feature (e.g., “FEATURE_1<=THRESHOLD_1”), and each branch corresponds to an outcome of the test (“TRUE” or “FALSE”). The process continues until a leaf node is reached, which provides a predicted value (“VALUE_2”, “VALUE_3”, etc.). In some embodiments, the random forest regressor model constructs multiple decision trees during training. For example, the model is initialized with a specified number of decision trees (e.g., 100). The random forest regressor model is then trained using a set of features (e.g., as determined by the feature selection module 114 and/or 214) and the corresponding target variable values.

According to at least one embodiment, a prediction is generated for a given input (X), by computing an average of the predictions from all individual decision trees in the forest, which can be mathematically represented as:

$$\hat{Y} ( X ) = \frac{1}{N} {\sum }_{i = 1}^{N} {T}_{i} ( X ) ,$$

where: Ý(X) is the predicted value for input X, N is the number of decision trees in the forest and Tᵢ(X) is the prediction from the i^{th} decision tree for input X.

Embodiments described herein are applicable to various types of tasks and use cases. For example, consider an ETL task processing large volumes of tabular data with high-throughput requirements that may involve substantial shuffle operations. Some embodiments can dynamically adjust a resource allocation to improve performance by continuously monitoring key metrics such as shuffle read/write bytes, execution memory usage and garbage collection times. The executor memory allocation and/or the number of executors can be dynamically adjusted to reduce job completion times and minimize overhead associated with garbage collection. Such an embodiment can ensure efficient processing even under demanding workloads, improving overall throughput and resource utilization.

As another example, consider a situation where a user needs to run ETL jobs with varying data formats (e.g., JavaScript Object Notation (JSON) or CSV) and sizes, each requiring different memory configurations for optimal performance. At least some embodiments can allow selection or training of different predictive models tailored to specific data characteristics (e.g., JSON data or CSV data). By adapting the prediction model based on the input data type and size, some embodiments can provide improved resource (e.g., memory) settings for each task, leading to increased performance and efficient resource utilization across heterogeneous workloads.

As yet another example, consider ETL pipelines with varying workloads and data sizes. Some embodiments can employ automated performance benchmarking to maintain favorable memory configurations. For example, the system can periodically benchmark different resource settings under representative conditions, continuously monitoring metrics (e.g., job execution time, memory usage and garbage collection overhead). Based on the benchmark results, the underlying ML model can be updated to reflect the most effective configurations, ensuring that the system dynamically adapts to changing workloads without manual intervention. This continuous improvement leads to increases in performance, resource utilization and reduced operational costs over time.

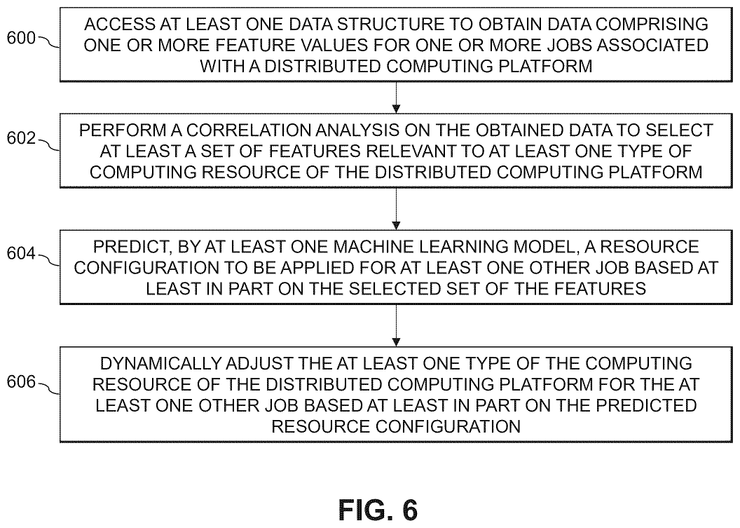

FIG. 6 shows a flow diagram of an adaptive resource configuration process in an illustrative embodiment. It is to be understood that this particular process is only an example, and additional or alternative processes can be carried out in other embodiments. In this embodiment, the process includes steps 600 through 606. These steps are assumed to be performed by the adaptive resource configuration system 105 and/or 205.

Step 600 includes accessing at least one data structure to obtain data comprising one or more feature values for one or more jobs associated with a distributed computing platform.

Step 602 includes performing a correlation analysis on the obtained data to select at least a set of features relevant to at least one type of computing resource of the distributed computing platform.

Step 604 includes predicting, by at least one machine learning model, a resource configuration to be applied for at least one other job based at least in part on the selected set of the features.

Step 606 includes dynamically adjusting the at least one type of the computing resource of the distributed computing platform for the at least one other job based at least in part on the predicted resource configuration.

In some embodiments, the at least one other job may include a different instance of at least one of the one or more jobs.

The process may further include retraining the at least one machine learning model based on performance feedback from jobs executed with a plurality of the predicted resource configurations.

The selected set of the features may correspond to a number of processor cores, a number of failed tasks, garbage collection time, a size of input data; one or more shuffle read/write statistics, an on-heap memory usage, an off-heap memory usage, an execution memory and/or one or more garbage collection events.

The at least one type of computing resource may include memory resources, processing resources, storage resources and/or networking resources.

The at least one machine learning model may include a random forest regression model.

The predicted resource configuration may be provided to a resource orchestrator within the distributed computing platform.

Dynamically adjusting the at least one type of the computing resource of the distributed computing platform may include adjusting allocations of the at least one type of computing resource across a plurality of computing nodes of the distributed computing platform, where the at least one other job is processed in parallel across the plurality of computing nodes as a plurality of tasks using the adjusted allocations.

The data may be obtained from at least one resource management system, at least one job history server and/or at least one log server.

It should be noted that the term “data structure” as used herein is intended to be broadly construed. A data structure, such as any single one of or combination of the data structures referred to above, may provide a portion of a larger data structure, or any one of or combination of the data structures may be combinations of multiple smaller data structures. Therefore, the data structures referred to above may be different parts of a same overall data structure, or one or more of the data structures could be made up of multiple smaller data structures. The data structures may include tables, vectors, embeddings, or various other data structures. In some embodiments, the data structures are specifically formatted or generated such that they are suitable for use as at least one of an input to and an output from an ML model. It should further be appreciated that “generating” a data structure may encompass, for example, populating an existing or previously-created data structure with one or more data items and that “accessing” a data structure may encompass, for example, obtaining a portion (e.g., one or more data items) of one or more data structures by means of a query, select or filter operation, for example.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The illustrative embodiments described herein can provide significant advantages relative to conventional approaches. For example, at least some embodiments described herein can dynamically optimize memory configurations in real time by leveraging ML models trained on historical and real-time data, thereby minimizing both under-provisioning (which can lead to job failures and performance degradation) and over-provisioning (which can lead to wasted resources). Such embodiments can achieve improved memory allocation and can reduce reliance on manual tuning while adapting to varying workloads, data characteristics and cluster conditions. By continuously monitoring metrics, at least some embodiments can ensure efficient resource utilization and enhanced job throughput. Additionally, the use of ensemble learning models provides a high level of accuracy, ensuring stable performance across diverse distributed processing frameworks. At least some embodiments also ensure the system remains robust to evolving workloads and system dynamics, offering improved scalability and reliability compared to static or manually configured approaches.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. A gain, containers may be used in combination with other virtualization infrastructure such as virtual machines implemented using a hypervisor.

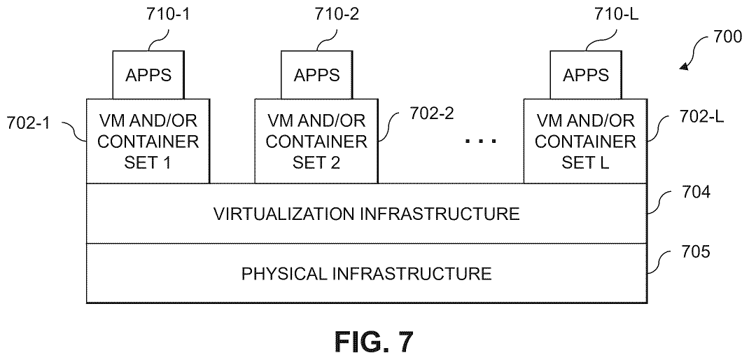

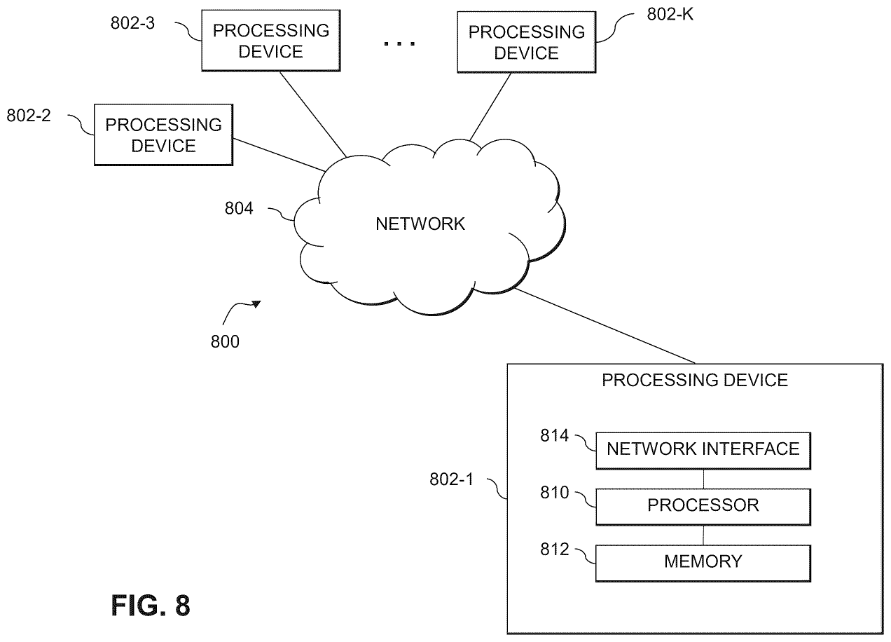

Illustrative embodiments of processing platforms will now be described in greater detail with reference to FIGS. 7 and 8. Although described in the context of information processing system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of the information processing system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a microcontroller, an ASIC, an FPGA, a CPU, a GPU, a TPU, a VPU, an NPU, a DPU, a SOC or other type of processing circuitry, as well as portions or combinations of such circuitry elements.

The memory 812 comprises RAM, ROM or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

A gain, the particular processing platform 800 shown in the figure is presented by way of example only, and information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed computing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
accessing at least one data structure to obtain data comprising one or more feature values for one or more jobs associated with a distributed computing platform;
performing a correlation analysis on the obtained data to select at least a set of features relevant to at least one type of computing resource of the distributed computing platform;
predicting, by at least one machine learning model, a resource configuration to be applied for at least one other job based at least in part on the selected set of the features; and
dynamically adjusting the at least one type of the computing resource of the distributed computing platform for the at least one other job based at least in part on the predicted resource configuration.

2. The computer-implemented method of claim 1, further comprising:
retraining the at least one machine learning model based on performance feedback from jobs executed with a plurality of the predicted resource configurations.

3. The computer-implemented method of claim 1, wherein the selected set of the features corresponds to at least one of: a number of processor cores; a number of failed tasks; a garbage collection time; a size of input data; one or more shuffle read/write statistics; an on-heap memory usage; an off-heap memory usage; an execution memory; and one or more garbage collection events.

4. The computer-implemented method of claim 1, wherein the at least one type of computing resource comprises at least one of: memory resources, processing resources, storage resources, and networking resources.

5. The computer-implemented method of claim 1, wherein the at least one machine learning model comprises a random forest regression model.

6. The computer-implemented method of claim 1, wherein the predicted resource configuration is provided to a resource orchestrator within the distributed computing platform.

7. The computer-implemented method of claim 6, wherein the dynamically adjusting the at least one type of the computing resource of the distributed computing platform comprises:
adjusting allocations of the at least one type of computing resource across a plurality of computing nodes of the distributed computing platform, wherein the at least one other job is processed in parallel across the plurality of computing nodes as a plurality of tasks using the adjusted allocations.

8. The computer-implemented method of claim 1, wherein the data is obtained from at least one of:
at least one resource management system,
at least one job history server; and
at least one log server.

9. A non-transitory processor-readable storage medium having stored therein program code of one or more software programs, wherein the program code when executed by at least one processing device causes the at least one processing device:
to access at least one data structure to obtain data comprising one or more feature values for one or more jobs associated with a distributed computing platform;
to perform a correlation analysis on the obtained data to select at least a set of features relevant to at least one type of computing resource of the distributed computing platform;
to predict, by at least one machine learning model, a resource configuration to be applied for at least one other job based at least in part on the selected set of the features; and
to dynamically adjust the at least one type of the computing resource of the distributed computing platform for the at least one other job based at least in part on the predicted resource configuration.

10. The non-transitory processor-readable storage medium of claim 9, wherein the program code when executed by the at least one processing device further causes the at least one processing device:
to retrain the at least one machine learning model based on performance feedback from jobs executed with a plurality of the predicted resource configurations.

11. The non-transitory processor-readable storage medium of claim 9, wherein the selected set of the features corresponds to at least one of: a number of processor cores; a number of failed tasks; a garbage collection time; a size of input data; one or more shuffle read/write statistics; an on-heap memory usage; an off-heap memory usage; an execution memory; and one or more garbage collection events.

12. The non-transitory processor-readable storage medium of claim 9, wherein the at least one type of computing resource comprises at least one of: memory resources, processing resources, storage resources, and networking resources.

13. The non-transitory processor-readable storage medium of claim 9, wherein the at least one machine learning model comprises a random forest regression model.

14. The non-transitory processor-readable storage medium of claim 9, wherein the predicted resource configuration is provided to a resource orchestrator within the distributed computing platform.

15. An apparatus comprising:
at least one processing device comprising a processor coupled to a memory;
the at least one processing device being configured:
to access at least one data structure to obtain data comprising one or more feature values for one or more jobs associated with a distributed computing platform;
to perform a correlation analysis on the obtained data to select at least a set of features relevant to at least one type of computing resource of the distributed computing platform;
to predict, by at least one machine learning model, a resource configuration to be applied for at least one other job based at least in part on the selected set of the features; and
to dynamically adjust the at least one type of the computing resource of the distributed computing platform for the at least one other job based at least in part on the predicted resource configuration.

16. The apparatus of claim 15, wherein the at least one processing device is further configured:
to retrain the at least one machine learning model based on performance feedback from jobs executed with a plurality of the predicted resource configurations.

17. The apparatus of claim 15, wherein the selected set of the features corresponds to at least one of: a number of processor cores; a number of failed tasks; a garbage collection time; a size of input data; one or more shuffle read/write statistics; an on-heap memory usage; an off-heap memory usage; an execution memory; and one or more garbage collection events.

18. The apparatus of claim 15, wherein the at least one type of computing resource comprises at least one of: memory resources, processing resources, storage resources, and networking resources.

19. The apparatus of claim 15, wherein the at least one machine learning model comprises a random forest regression model.

20. The apparatus of claim 15, wherein the predicted resource configuration is provided to a resource orchestrator within the distributed computing platform.
